(19) United States
(12) Patent Application Publication
(10) Pub. No.: US 2007/0003304 A1
(43) Pub. Date: Jan. 4, 2007

(54) Sublimable image forming apparatus and method of controlling the same

(75) Inventor: Jeong-Baek Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/395,254

(22) Filed: Apr. 3, 2006

(30) Foreign Application Priority Data
Jun. 8, 2005 (KR) 2005-0049037

(51) Int. Cl. G03G 15/01

(52) U.S. Cl. 399/54

(57) ABSTRACT

A sublimable image forming apparatus and a method of controlling the same are provided. The apparatus comprises a main body having an image forming unit provided therein, and an access opening through which a recoding medium goes in and out during an image forming process, and a display unit disposed at the main body to display an instruction to determine whether a margin of the recording medium is obtained such that the recording medium can go in and out through the access opening in a progress direction of the recording medium. Whereby it is possible to perform a stable image forming process by allowing the user to determine whether a margin is sufficiently obtained at the rear part of the recording medium opposite to the access opening through which the recording medium goes in and out during the image forming process and to manipulate the manipulation unit before performing the image forming process, although the user is still not aware of the operation manual or is not careful in using the image forming apparatus.

### CROSS-REFERENCE TO RELATED APPLICATION

This application claims the benefit under 35 U.S.C. § 119(a) of a Korean Patent Application, assigned Serial No. 2005-49037, filed Jun. 8, 2005, in the Korean Intellectual Property Office, the entire disclosure of which is hereby incorporated by reference.

### BACKGROUND OF THE INVENTION

1. Field of the Invention

The present invention relates to a sublimable image forming apparatus. and a method of controlling the same. More particularly, the present invention relates to a sublimable image forming apparatus capable of determining whether a margin of a recording medium such as paper is obtained at a rear section, through which the recording medium goes in and out during image formation, and a method of controlling the same.

2. Description of the Related Art

In general, a sublimable image forming apparatus comprises a film-shaped ribbon coated with ink between a thermal head and a recording medium to transfer the ink sublimated in a predetermined pattern by the thermal head from the ribbon to the recording medium, thereby forming an image. The sublimable image forming apparatus transfers a color-separated image repeatedly. Typically three colors are used, namely yellow, magenta and cyan to realize a full color.

However, when the image forming apparatus is small, the recording medium repeatedly goes in and out through the image forming apparatus during the repeated transfer operation. Recently, sublimable image forming apparatus, thereby causing the recording medium to frequently be exposed during an image forming process.

Therefore, in order to allow the recording medium to go in and out of the image forming apparatus during the image forming process, it is necessary to obtain a sufficient margin at a rear part opposite to the exposed part of the recording medium. The margin may be obtained through appropriate position adjustment of the image forming apparatus.

However, the user may be not previously aware of the functional characteristics. Therefore, when the image forming process is performed in the state that the margin is not obtained due to unawareness of the user, the recording medium going in and out through the apparatus may be damaged.

### SUMMARY OF THE INVENTION

In order to solve the foregoing and/or other problems, an aspect of the present invention is to provide a sublimable image forming apparatus and a method of controlling the same which may inform a user of whether a margin of a recording medium is obtained such that the recording medium may go in and out through the image forming apparatus in a progress direction of the recording medium.

Another aspect of the present invention is to provide a sublimable image forming apparatus and a method of controlling the same which may detect whether a margin of a recording medium is obtained such that the recording medium may go in and out through the image forming apparatus in a progress direction of the recording medium, and then inform a user of the result.

Other aspects and advantages of exemplary embodiment of the present invention will be set forth in part in the description which follows and, in part, will be obvious from the description, or may be learned by practice of the invention.

According to an exemplary embodiment of the present invention, a sublimable image forming apparatus is provided. The apparatus comprises a main body having an image forming unit provided therein, and an access opening through which a recoding medium goes in and out during an image forming process, and a display unit disposed at the main body to display to determine whether a margin of the recording medium is obtained such that the recording medium goes in and out through the access opening in a progress direction of the recording medium.

Preferably, the apparatus further comprises a manipulation unit disposed on the main body for inputting the determination result whether the margin of the recording medium is obtained.

In addition, preferably, the apparatus further comprises an alarm unit for performing the image forming process when the determination is input into the manipulation unit within a predetermined time, and generating an alarm when the determination is not input within the predetermined time.

Preferably, the apparatus further comprises a detection sensor installed at one surface of the main body, at which the access opening is formed.

Preferably, the display unit displays whether the margin is obtained at a rear part of the recording medium opposite to the access opening according to the detected result of the detection sensor.

Preferably, a plurality of detection sensors are installed at different positions of the one surface of the main body.

Preferably, the detection sensor is one of an infrared sensor and a photo sensor.

Preferably, the image forming unit comprises a ribbon cartridge having ink ribbons sequentially wound in an order of yellow, cyan, magenta and overcoat, a thermal head for applying heat to one surface of each ink ribbon, and a platen roller for supporting the other surface of each ink ribbon and the supplied recording medium.

In addition, preferably, the image forming unit comprises a ribbon cartridge having ink ribbons sequentially wound in an order of yellow, cyan, magenta and overcoat, a laser light source for scanning light to one surface of each ink ribbon to generate transfer heat through light-to-heat conversion, and a platen roller for supporting the other surface of each ink ribbon and the supplied recording medium.

According to an exemplary embodiment of the present invention, a sublimable image forming apparatus is provided. The apparatus comprises a main body, a ribbon cartridge installed in the main body and having ink ribbons sequentially wound in an order of yellow, cyan, magenta, and overcoat, a heating member for applying heat to one surface of each ink ribbon, a platen roller for supporting the other surface of each ink ribbon and the supplied recording medium, an access opening installed at one surface of the main body, and through which a recoding medium goes in and out during an image forming process, a display unit disposed at the main body to display to determine whether a margin of the recording medium is obtained such that the recording medium goes in and out through the access opening in a progress direction of the recording medium, a manipulation unit disposed on the main body to input the determination result whether the margin of the recording medium is obtained, and an alarm unit for performing the image forming process when the determination result is input into the manipulation unit within a predetermined time, and generating an alarm when the determination result is not input within the predetermined time.

Preferably, the apparatus further comprises a detection sensor installed at one surface of the main body, at which the access opening is formed.

Preferably, the display unit displays whether the margin is obtained at a rear part of the recording medium opposite to the access opening according to the detected result of the detection sensor.

Preferably, a plurality of detection sensors is installed at different positions of the one surface of the main body.

Preferably, the detection sensor is one of an infrared sensor and a photo sensor.

Preferably, the heating member is one of a thermal head and a laser light source for generating transfer heat through light-to- heat conversion.

According to an exemplary embodiment of the present invention, a method of controlling a sublimable image forming apparatus is provided. The method comprises inputting an image forming order. An instruction is displayed to determine whether a margin of a recording medium is obtained such that the s recording medium can go in and out in a progress direction of the recording medium during an image forming process, when the image forming order is input.

Preferably, the method further comprises inputting the determination result whether the margin of the recording medium is obtained.

Preferably, the method further comprises performing the image forming process when the determination result is input within a predetermined time, and generating an alarm when the determination result is not input within the predetermined time.

Preferably, the method further comprises detecting whether a predetermined margin of the recording medium is obtained such that the recording medium goes in and out in a progress direction of the recording medium when the image forming order is input.

In addition, preferably, the method further comprises performing the image forming process when it is detected that the margin is obtained.

Preferably, the method further comprises performing the image forming process when the determination result is input within a predetermined time after displaying to determine, and generating an alarm when the determination result is not input within the predetermined time.

According to an exemplary embodiment of the present invention, a method of controlling a sublimable image forming apparatus is provided. The method comprises inputting an image forming order, determining whether a predetermined margin of a recording medium is obtained such that the recording medium can go in and out in a progress direction of the recording medium during an image forming process, performing the image forming process when it is determined that the predetermined margin is obtained, and displaying an instruction to determine whether the predetermined margin is obtained at a rear part of the recording medium when it is determined that the predetermined margin is not obtained. The image forming process is performed when the determination result is input within a predetermined time after displaying to determine whether the predetermined margin is obtained, and an alarm is generated when the determination result is not input within the predetermined time.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a perspective view illustrating a sublimable image forming apparatus in accordance with an exemplary embodiment of the present invention;

FIG. 2 is a block diagram illustrating a sublimable image forming apparatus in accordance with an exemplary embodiment of the present invention;

FIG. 3 is a side cross-sectional view illustrating an inner structure of a sublimable image forming apparatus in accordance with an exemplary embodiment of the present invention;

FIG. 4 is a flowchart illustrating a method of controlling a sublimable image forming apparatus in accordance with an exemplary embodiment of the present invention; and

FIG. 5 is a flowchart illustrating a method of controlling a sublimable image forming apparatus in accordance with an exemplary embodiment of the present invention.

Throughout the drawings, like reference numerals will be understood to refer to like parts, components and structures.

### DETAILED DESCRIPTION OF EXEMPLARY EMBODIMENTS

Reference will now be made in greater detail to the embodiments of the present invention, examples of which are illustrated in the accompanying drawings. The embodiments are described below in order to explain the present invention by referring to the figures.

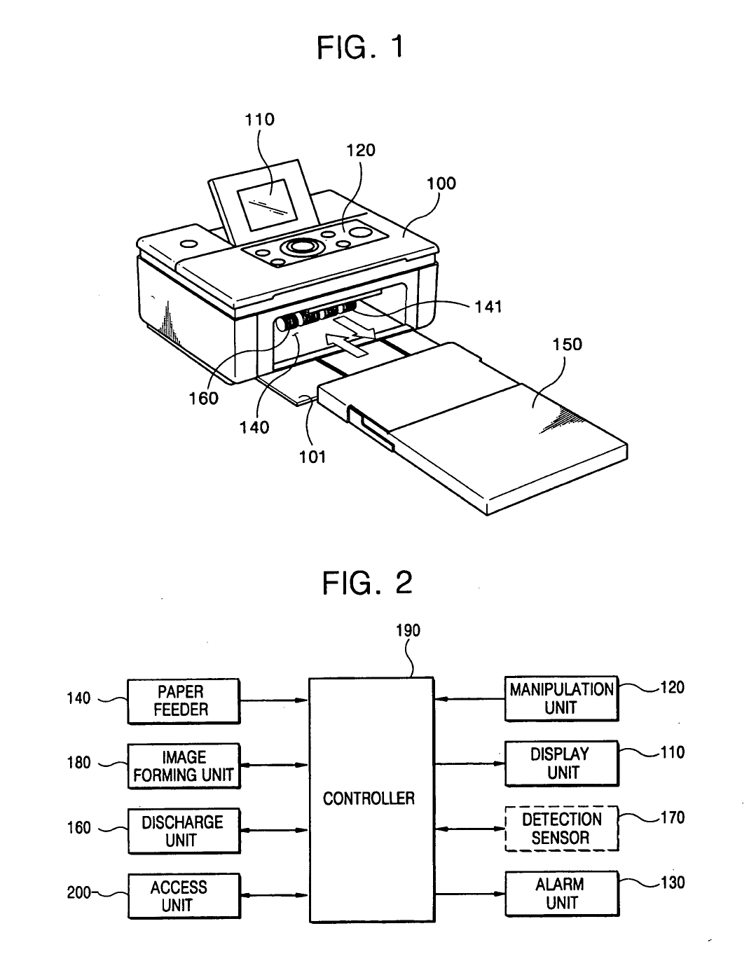

FIG. 1 is a perspective view illustrating a sublimable image forming apparatus in accordance with an exemplary embodiment of the present invention, and FIG. 2 is a block diagram illustrating a sublimable image forming apparatus in accordance with an exemplary embodiment of the present invention.

As shown in FIGS. 1 and 2, a sublimable image forming apparatus in accordance with an exemplary embodiment of the present invention comprises a main body 100, and a display unit 110 formed of an LCD panel installed on the main body 100 to display an operation state of the image forming apparatus.

A manipulation unit 120 having a plurality of buttons for manipulating the image forming apparatus is installed in front of the display unit 110. In addition, the image forming apparatus comprises an alarm unit 130 formed of a speaker for audibly informing an operation state of the image forming apparatus, an LED lamp, or the like.

A paper feeder 140 is installed in front of the main body 100, and a paper cartridge 150 is detachably mounted to the main body 100 to supply a paper to an image forming unit 180 installed in the main body 100.

In addition, a discharge unit 160 for discharging a recording medium at which the image forming process is completed is formed over the paper feeder 140. Then, the recording medium is discharged to be stacked on the paper cartridge 150. Meanwhile, a cover 101 for covering the paper feeder 140 and the discharge unit 160 is hinged in front of the main body 100, and an access unit 200 through which the recording medium goes in and out during the image forming process of the image forming unit 180 is formed at a rear part of the main body 100.

An external device connecting unit such as an Universal Serial Bus (USB) port (not shown), a memory card slot (not shown), or the like is installed at the main body 100 to enable input of image data, and a power connecting device for supplying external power is also installed at the main body 100.

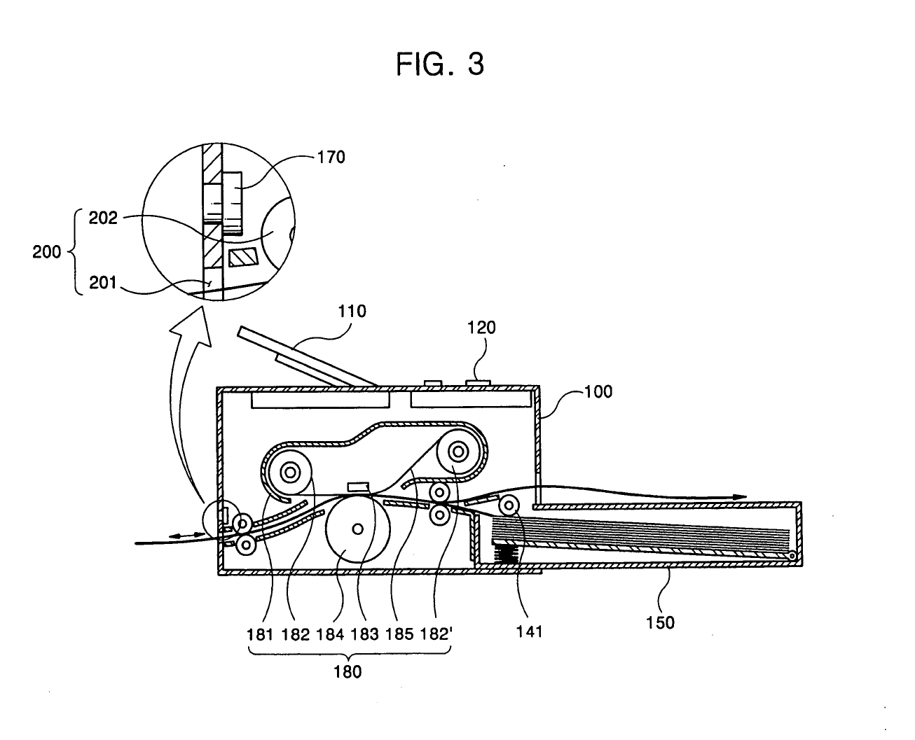

FIG. 3 is a side cross-sectional view illustrating an inner structure of a sublimable image forming apparatus in accordance with an exemplary embodiment of the present invention. Describing the inner structure of the main body 100 with reference to FIG. 3, the image forming unit 180 comprises a ribbon cartridge 181 detachably mounted into the main body 100.

The ribbon cartridge 181 comprises a ribbon 185 wound between two rollers 182 and 182′, and a heating member 183 disposed on the ribbon 185 to apply heat to the ribbon 185 to form an image. The heating member 183 may comprise a thermal head for directly applying heat to the ribbon, or a laser light source for scanning light to the ribbon to generate transfer heat through light-to-heat conversion.

The ribbon 185 has a color array such that cyan, magenta, yellow and overcoat are sequentially disposed. Therefore, the image forming process is performed by sequentially sublimating cyan, magenta, and yellow regions on a surface of the recording medium using the heating member 183, and then overcoat for coating a passivation layer is also sublimated by the heating member 183, thereby forming an image on the recording medium. The sequence of the array of cyan, magenta and yellow may be changed, except that the overcoat is applied after the colors.

A platen roller 184 is installed under the ribbon cartridge 181 to support a lower surface of the recording medium. In addition, a paper feed roller 141 included in the paper feeder 140 is installed in front of the platen roller 184. In this process, the platen roller 184 is rotatably mounted by a reversible motor in a bi-directional manner to convert the direction of the image forming process.

Meanwhile, the access unit 200 comprises a paper access opening 201 formed at a rear part of the main body 100, and an access roller 202 for moving a recording medium through the access opening 201. The recording medium may be moved by the paper conveyance of the image forming unit 180, without installing the access roller 202.

In addition, at least one detection sensor 170 may be installed around the access opening 201, and the detection sensor 170 functions to detect whether another object exists at a rear part of the access opening 201. While one detection sensor 170 or more may be installed, when a plurality of detection sensors are installed at different positions, it is possible to more precisely detect whether another object exists at the rear part of the access opening 201. The detection sensor 170 may employ an infrared sensor, a photo sensor, or any other suitable sensor.

According to an exemplary embodiment of the present invention, the detection sensor 170 need not be installed. That is, even if the detection sensor 170 is not installed, it is possible to determine whether the margin is obtained, and the detection sensor 170 may be provided in another embodiment having an additional function.

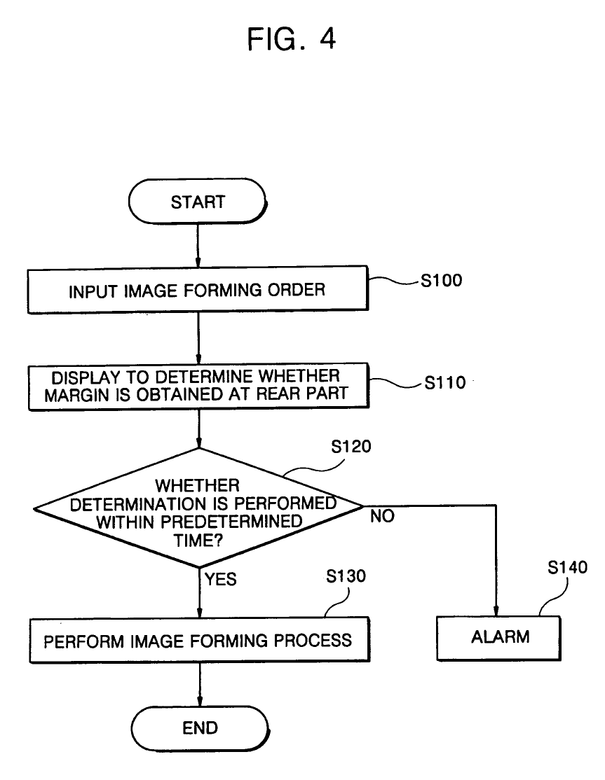

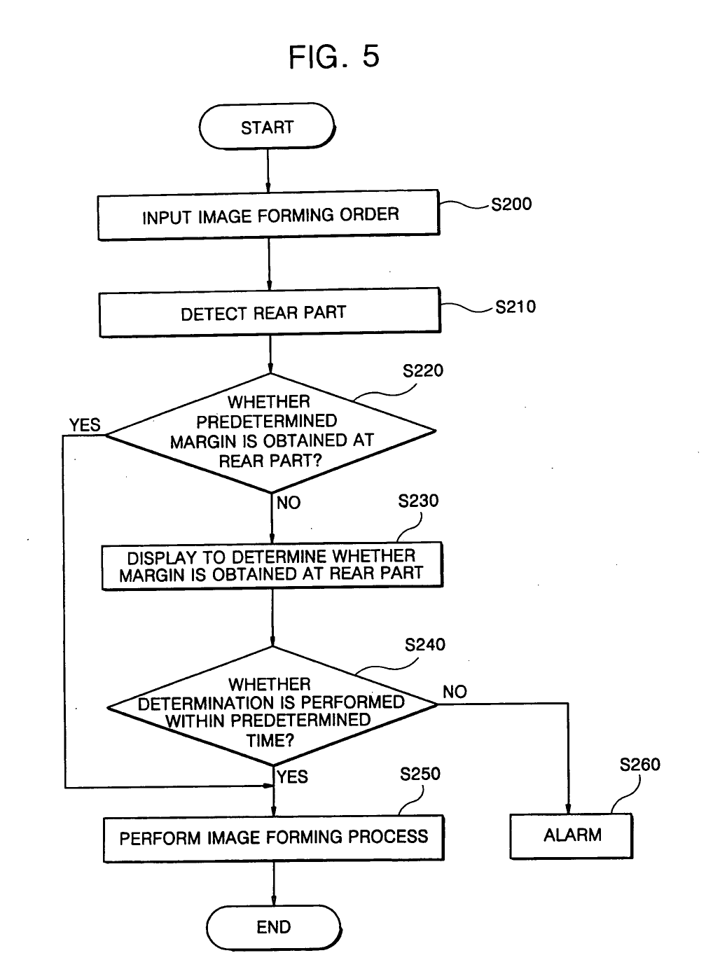

Hereinafter, a method of controlling a sublimable image forming apparatus in accordance with an exemplary embodiment of the present invention will be described in conjunction with FIGS. 4 and 5.

FIG. 4 is a flowchart illustrating a method of controlling a sublimable image forming apparatus in accordance with an exemplary embodiment of the present invention. This embodiment may be adapted when the detection sensor is not employed or out of order.

In order to perform the image forming process, it is necessary to transmit image data to a controller 190 of the main body 100 through the external device connecting unit. After or while transmitting the image data to the controller 190, a user inputs an image forming order through the manipulation unit 120 at step S100.

When the image forming order is input, before a recording medium is supplied or the image forming process is performed, an instruction is displayed at the display unit 110 that a user should determine whether a predetermined margin of the recording medium is obtained at a rear part of the recording medium opposite to the access opening 201 of the main body 100 at step S110.

Then, when it is determined that the user pushes a confirmation button through the manipulation unit 120 within a predetermined time to confirm that a predetermined margin of the recording medium is obtained at step S120, the image forming process is performed at step S130.

On the other hand, when it is determined that the user does not push the confirmation button through the manipulation unit 120 within the predetermined time, the controller 190 recognizes that the margin is not confirmed or insufficiently obtained, thereby generating an audible or visual alarm through the alarm unit 130 at step S140. Then, the user releases the alarm after confirming the alarm, and then inputs again an image forming order, thereby repeatedly performing the abovementioned operation.

FIG. 5 is a flowchart illustrating a method of controlling a sublimable image forming apparatus in accordance with an exemplary embodiment of the present invention. The apparatus comprises the detection sensor to detect whether the predetermined margin is previously obtained at a rear part of the recording medium opposite to the access opening.

According to an exemplary embodiment of the present invention, the user inputs an image forming order at step S200. Then, the detection sensor 170 detects whether the predetermined margin is obtained at the rear part of the recording medium opposite to the access opening 201 at step S210. Next, the controller 190 determines whether the predetermined margin is obtained at the rear part according to the detected result of the detection sensor 170 at step S220.

As a result of the determination, when it is determined that the predetermined margin is obtained at the rear part, the image forming process is performed at step S250. On the other hand, when it is determined that the predetermined margin is not obtained, it is requested to the user through the display unit 110 that the user should confirm whether the predetermined margin is obtained at step S230.

Then, when it is determined that the user pushes a confirmation button through the manipulation unit 120 within a predetermined time to confirm that a predetermined margin of the recording medium is obtained at step S240, the image forming process is performed at step S250. On the other hand, when it is determined that the user does not push the confirmation button through the manipulation unit 120 within the predetermined time, the controller 190 recognizes that the margin is not confirmed or insufficiently obtained, thereby generating an audible or visual alarm through the alarm unit 130 at step S260. Then, the user releases the alarm after confirming the alarm, and then inputs again an image forming order, thereby repeatedly performing the abovementioned operation.

As can be seen from the foregoing, the exemplary embodiments of the present invention will be modified by partially changing each component. For example, without installing the display unit, a specific audio signal previously input into a memory may be generated to request the confirmation to the user, or a plurality of detection sensors may be installed to determine whether a spatial space is obtained.

In addition, the present invention can be adapted to a color image forming process as well as a monochrome image forming process for coating a passivation layer. However, when the basic components of the modified exemplary embodiment comprise essential components of the present invention, it will be defined in the scope of the present invention.

The sublimable image forming apparatus and the method of controlling the same in accordance with exemplary embodiments of the present invention are capable of improving use efficiency of the image forming apparatus and minimizing damage of the recording medium through a stable image forming process by allowing the user to determine whether the margin is sufficiently obtained at the rear part of the recording medium opposite to the access opening through which the recording medium goes in and out during the image forming process and to manipulate the manipulation unit before performing the image forming process, even though the user is not familiar with the operation manual or is not careful in using the image forming apparatus.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A sublimable image forming apparatus, comprising:
a main body having an image forming unit provided therein, and an access s opening through which a recoding medium goes in and out during an image forming process; and
a display unit disposed at the main body to display an instruction to determine whether a margin of the recording medium is obtained such that the recording medium can go in and out through the access opening in a progress direction of the recording medium.

2. The apparatus according to claim 1, further comprising a manipulation unit disposed on the main body for inputting the determination result whether the margin of the recording medium is obtained.

3. The apparatus according to claim 2, further comprising an alarm unit for performing the image forming process when the determination result is input into the manipulation unit within a predetermined time, and generating an alarm when the determination result is not input within the predetermined time.

4. The apparatus according to claim 1, further comprising a detection sensor installed at one surface of the main body, at which the access opening is formed.

5. The apparatus according to claim 4, wherein the display unit displays whether the margin is obtained at a rear part of the recording medium opposite to the access opening according to the detected result of the detection sensor.

6. The apparatus according to claim 4, wherein a plurality of detection sensors are installed at different positions of the one surface of the main body.

7. The apparatus according to claim 4, wherein the detection sensor is one of an infrared sensor and a photo sensor.

8. The apparatus according to claim 1, wherein the image forming unit comprises:
a ribbon cartridge having ink ribbons sequentially wound in an order of yellow, cyan, magenta, and overcoat;
a thermal head for applying heat to one surface of each ink ribbon; and
a platen roller for supporting the other surface of each ink ribbon and the supplied recording medium.

9. The apparatus according to claim 1, wherein the image forming unit comprises:
a ribbon cartridge having ink ribbons sequentially wound in an order of yellow, cyan, magenta, and overcoat;
a laser light source for scanning light to one surface of each ink ribbon to generate transfer heat through light-to-heat conversion; and
a platen roller for supporting the other surface of each ink ribbon and the supplied recording medium.

10. A sublimable image forming apparatus, comprising:
a main body;
a ribbon cartridge installed in the main body and having a plurality of ink ribbons sequentially wound in a specified order;
a heating member for applying heat to one surface of each ink ribbon;
a platen roller for supporting the other surface of each ink ribbon and the supplied recording medium;
an access opening installed at one surface of the main body, and through which a recoding medium goes in and out during an image forming process;
a display unit disposed at the main body to display an instruction to determine whether a margin of the recording medium is obtained such that the recording medium can go in and out through the access opening in a progress direction of the recording medium;
a manipulation unit disposed on the main body to input the determination result whether the margin of the recording medium is obtained; and
an alarm unit for performing the image forming process when the determination result is input into the manipulation unit within a predetermined time, and generating an alarm when the determination result is not input within the predetermined time.

11. The apparatus according to claim 10, further comprising a detection sensor installed at one surface of the main body, at which the access opening is formed.

12. The apparatus according to claim 11, wherein the display unit displays whether the margin is obtained at a rear part of the recording medium opposite to the access opening according to the detected result of the detection sensor.

13. The apparatus according to claim 11, wherein a plurality of detection sensors are installed at different positions of the one surface of the main body.

14. The apparatus according to claim 11, wherein the detection sensor is one of an infrared sensor and a photo sensor.

15. The apparatus according to claim 10, the heating member is a thermal head.

16. The apparatus according to claim 10, the heating member is a laser light source for generating transfer heat through light-to- heat conversion.

17. A method of controlling a sublimable image forming apparatus, comprising:
receiving an image forming instruction; and
displaying an instruction to determine whether a margin of a recording medium is obtained such that the recording medium goes in and out in a progress direction of the recording medium during an image forming process, when the image forming order is input.

18. The method according to claim 17, further comprising inputting the determination result whether the margin of the recording medium is obtained.

19. The method according to claim 18, further comprising performing the image forming process when the determination result is input within a predetermined time, and generating an alarm when the determination result is not input within the predetermined time.

20. The method according to claim 17, further comprising detecting whether a predetermined margin of the recording medium is obtained such that the recording medium goes in and out in a progress direction of the recording medium when the image forming order is input.

21. The method according to claim 20, further comprising performing the image forming process when it is detected that the margin is obtained.

22. The method according to claim 21, further comprising performing the image forming process when the determination result is input within a predetermined time after displaying to determine whether the predetermined margin is obtained, and generating an alarm when the determination result is not input within the predetermined time.

23. A method of controlling a sublimable image forming apparatus, comprising:
receiving an image forming instruction;
displaying an instruction to determine whether a margin of a recording medium is obtained such that the recording medium goes in and out in a progress direction of the recording medium during an image forming process when the image forming order is input;
inputting the determination result whether the margin of the recording medium is obtained; and
performing the image forming process when the determination result is input within a predetermined time, and generating an alarm when the determination result is not input within the predetermined time.

24. A method of controlling a sublimable image forming apparatus, comprising:
receiving an image forming instruction;
determining whether a predetermined margin of a recording medium is obtained such that the recording medium goes in and out in a progress direction of the recording medium during an image forming process;
performing the image forming process when it is determined that the predetermined margin is obtained, and displaying an instruction to determine whether the predetermined margin is obtained at a rear part of the recording medium when it is determined that the predetermined margin is not obtained; and
performing the image forming process when the determination result is input within a predetermined time after displaying an instruction to determine whether the predetermined margin is obtained, and generating an alarm when the determination result is not input within the predetermined time.
